(19) United States
(12) Patent Application Publication
(10) Pub. No.: US 2019/0268903 A1
(43) Pub. Date: Aug. 29, 2019

(54) TRANSMISSION OR RECEPTION METHOD IN WIRELESS COMMUNICATION SYSTEM, AND DEVICE THEREFOR

(71) Applicant: LG Electronics Inc., Seoul (KR)

(72) Inventors: Hyunho LEE, Seoul (KR); Yunjung YI, Seoul (KR); Hyunsoo KO, Seoul (KR); Seungmin LEE, Seoul (KR)

(21) Appl. No.: 16/307,784

(22) PCT Filed: May 26, 2017
(86) PCT No.: PCT/KR2017/005531

§ 371 Date: Dec. 6, 2018

Related U.S. Application Data
(60) Provisional application No. 62/347,041, filed on Jun. 7, 2016.

(51) Int. Cl. H04W 72/04; H04L 1/18; H04W 72/14; H04W 72/12

(52) U.S. Cl. CPC H04W 72/0446; H04W 72/1278; H04W 72/14; H04L 1/1812

(57) ABSTRACT

A transmission or reception method for a terminal, for which a pair of an uplink spectrum and a downlink spectrum have been configured, in a wireless communication system according to an embodiment of the present invention may comprise the steps of: receiving subframe configuration information to be applied in an uplink spectrum or a downlink spectrum from a network; and performing a transmission or reception operation in the uplink spectrum or the downlink spectrum by using the received subframe configuration, wherein the subframe configuration indicates a downlink-related operation in the uplink spectrum or indicates an uplink-related operation in the downlink spectrum, and the subframe configuration is included in downlink control information received in a spectrum, in which the transmission or reception operation will be performed, or another spectrum.

### TECHNICAL FIELD

The present invention relates to a wireless communication system and, more particularly, to a transmission and reception method in a wireless communication system and an apparatus therefor.

### BACKGROUND ART

As more communication devices have demanded higher communication capacity, there has been necessity of enhanced mobile broadband (eMBB) communication as compared with legacy radio access technology (RAT). In addition, massive machine type communication (MTC) for providing various services anytime and anywhere by connecting a plurality of devices and objects to each other is also one main issue to be considered in next-generation communication. Moreover, a communication system to be designed in consideration of services/UEs sensitive to reliability and latency is under discussion. Thus, the introduction of next-generation RAT has been discussed by taking into consideration eMBB communication, massive MTC (mMTC), ultra-reliable and low-latency communication (URLLC), and the like. In the present invention, the above technology is referred to as new RAT.

### DETAILED DESCRIPTION OF THE INVENTION

### Technical Problems

The present invention provides a transmission and reception method through flexible resource configuration in a wireless communication system and an operation related thereto.

The objects that can be achieved with the present invention are not limited to what has been particularly described hereinabove and other objects not described herein will be more clearly understood by persons skilled in the art from the following detailed description.

### Technical Solutions

According to an aspect of the present invention, provided herein is a method for transmitting and receiving for a terminal for which a pair of an uplink (UL) spectrum and a downlink (DL) spectrum is configured in a wireless communication system. The method may include receiving information about subframe configuration to be applied to the UL spectrum or the DL spectrum from a network; and performing transmission and reception operations using the subframe configuration in the UL spectrum or the DL spectrum. The subframe configuration may be included in DL control information received in a spectrum in which the transmission and reception operations are to be performed or other spectrums. The subframe configuration may indicate a DL related operation of the terminal in the UL spectrum or indicate a UL related operation of the terminal in the DL spectrum, and

Additionally or alternatively, the subframe configuration may indicate information about how at least a part of a DL control region, a DL data region, a guard period region, a UL control region, and a UL data region is configured in a subframe.

Additionally or alternatively, the subframe configuration may include information about a time or frequency resource range, a period, or an offset to which the subframe configuration is to be applied.

Additionally or alternatively, the subframe configuration may be configured cell-commonly, terminal group-specifically, or terminal-specifically.

Additionally or alternatively, when a DL transmission of the terminal based on the received subframe configuration overlaps with an UL transmission of another terminal, the UL transmission of the another terminal may be punctured.

Additionally or alternatively, wherein when a DL transmission of the terminal based on the received subframe configuration overlaps with an UL transmission of another terminal, the DL transmission of the terminal may be punctured.

Additionally or alternatively, a spectrum in which the subframe configuration is received and a time or frequency resource in the spectrum may be pre-configured for the terminal.

Additionally or alternatively, hybrid automatic repeat request acknowledgement/non-acknowledgement (HARQ-ACK) feedback for DL data scheduled in each of the UL spectrum and the DL spectrum according to the received subframe configuration may be multiplexed and transmitted on a UL control channel in one of the UL spectrum and the DL spectrum.

Additionally or alternatively, resource element (RE) mapping of the HARQ-ACK feedback to the UL control channel may be performed based on priority of the HARQ-ACK feedback, a HACK-ACK for DL data scheduled in the DL spectrum may have a higher priority than a HARQ-ACK for DL data scheduled in the UL spectrum, and a HARQ-ACK for DL data scheduled in an earlier transmission time interval (TTI) may have a higher priority than a HARQ-ACK for DL data scheduled in a later TTI.

In another aspect of the present invention, provided herein is a terminal for which a pair of an uplink (UL) spectrum and a downlink (DL) spectrum is configured in a wireless communication system, including a transmitter and a receiver; and a processor configured to control the transmitter and the receiver. The processor may be configured to receive information about subframe configuration to be applied to the UL spectrum or the DL spectrum from a network and perform transmission and reception operations using the received subframe configuration in the UL spectrum or the DL spectrum. The subframe configuration may indicate a DL related operation of the terminal in the UL spectrum or indicate a UL related operation of the terminal in the DL spectrum. The subframe configuration may be included in DL control information received in a spectrum in which the transmission and reception operations are to be performed or other spectrums.

The foregoing solutions are merely a part of the embodiments of the present invention and various embodiments into which the features of the present invention are incorporated can be derived and understood by persons skilled in the art from the following detailed description of the present invention.

### Advantageous Effects

According to an embodiment of the present invention, transmission or reception in a wireless communication system can be efficiently performed.

The effects that can be achieved with the present invention are not limited to what has been particularly described hereinabove and other advantages not described herein will be more clearly understood by persons skilled in the art from the following detailed description of the present invention.

### DESCRIPTION OF DRAWINGS

The accompanying drawings, which are included to provide a further understanding of the present invention, and are incorporated in and constitute a part of this specification, illustrate embodiments of the invention and together with the description serve to explain the principles of the invention.

FIG. 1 illustrates an exemplary radio frame structure in a wireless communication system.

FIG. 2 illustrates an exemplary downlink/uplink (DL/UL) slot structure in the wireless communication system.

FIG. 3 illustrates an exemplary DL subframe structure in a 3GPP LTE/LTE-A system.

FIG. 4 illustrates an exemplary UL subframe structure in the 3GPP LTE/LTE-A system.

FIG. 5 illustrates a self-contained subframe structure.

FIG. 6 illustrates subframe configuration.

FIG. 7 illustrates subframe configuration.

FIGS. 8, 9, and 10 illustrates HARQ-ACK timings according to embodiments of the present invention.

FIG. 11 illustrates the operation of a UE.

FIG. 12 is a block diagram for implementing embodiment(s) of the present invention.

### BEST MODE FOR CARRYING OUT THE INVENTION

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e., single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to multiple nodes may control the nodes such that signals are simultaneously transmitted to or received from a UE through some or all nodes. While there is a difference between multi-node systems according to the nature of each node and implementation form of each node, multi-node systems are discriminated from single node systems (e.g., a centralized antenna system (CAS), conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes may be applied to various types of multi-node systems. For example, a node refers to an antenna group spaced apart from another node by a predetermined distance or more, in general. However, embodiments of the present invention, which will be described below, may even be applied to a case in which a node refers to an arbitrary antenna group irrespective of node interval. In the case of an eNB including an X-pole (cross-polarized) antenna, for example, the embodiments of the preset invention are applicable on the assumption that the eNB controls a node composed of an H-pole antenna and a node composed of a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

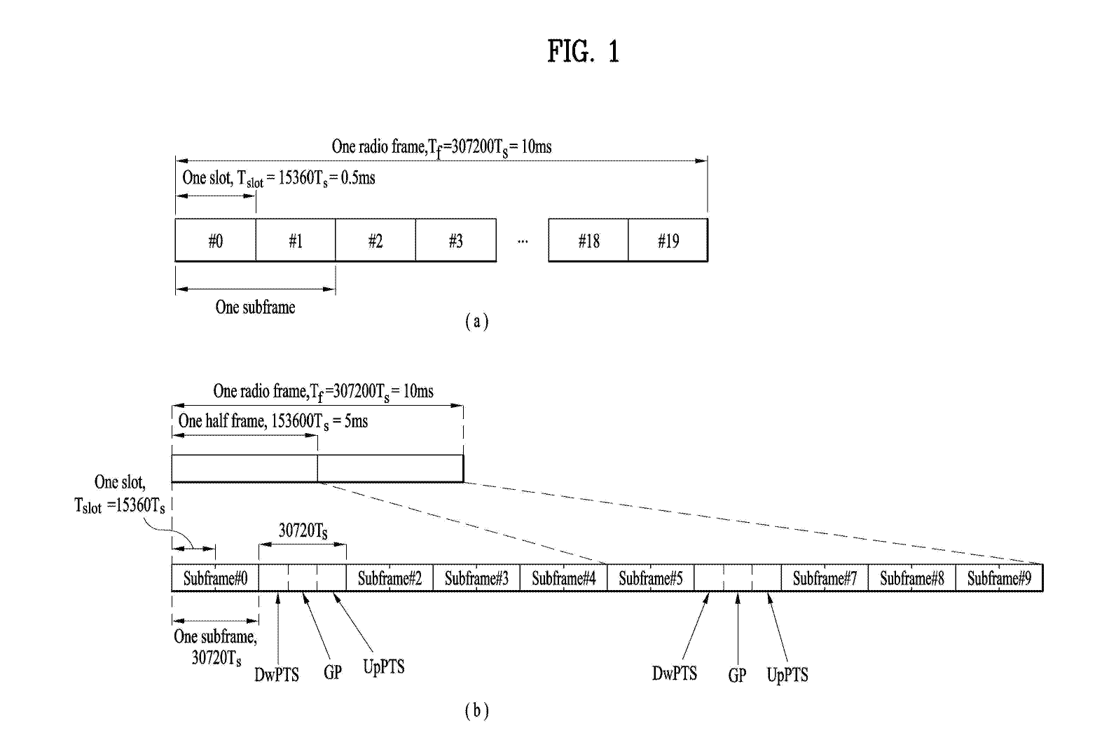

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| DL-UL | to-Uplink | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

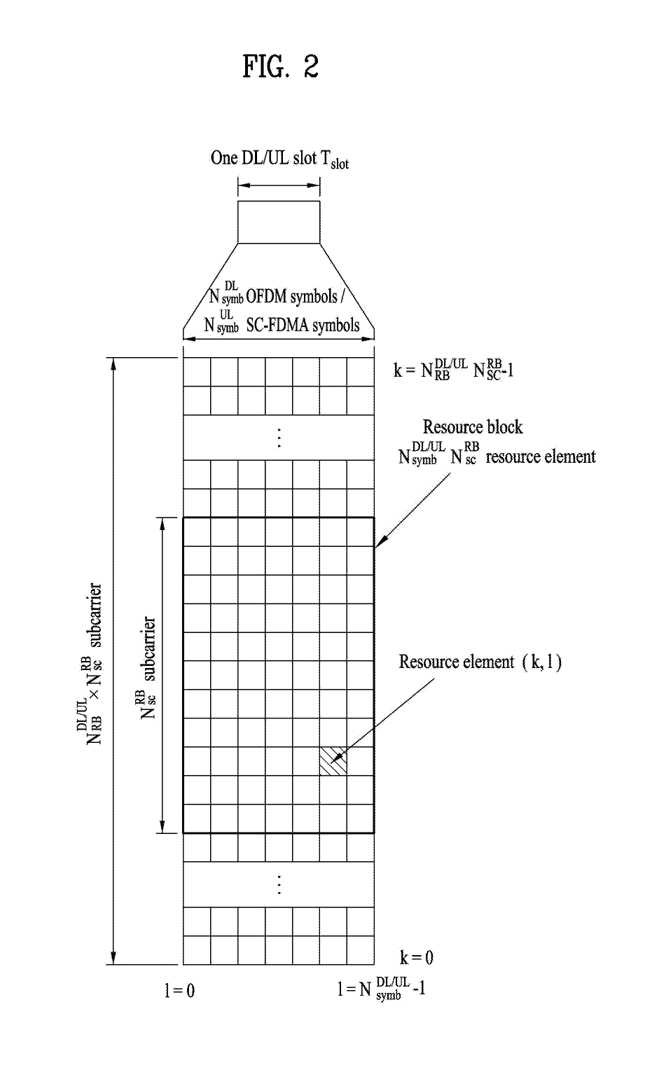

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{RB}^{DL/UL}*N_{sc}^{RB} REs. Each RE in a resource grid can be uniquely defined by an index pair (k, l) in a slot. Here, k is an index in the range of 0 to N_{RB}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{LD}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

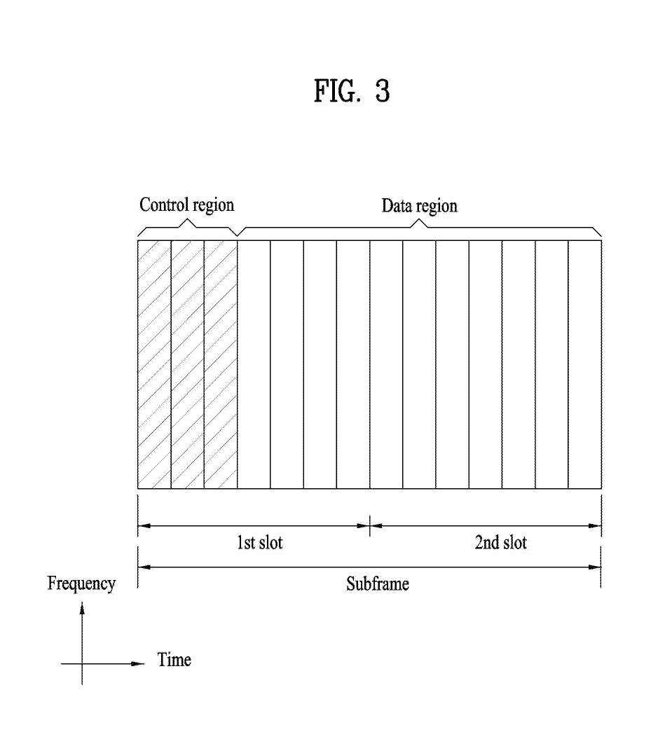

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | |
|---|---|---|---|
| | Aggregation | | Number of PDCCH |
| Type | Level L | Size [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

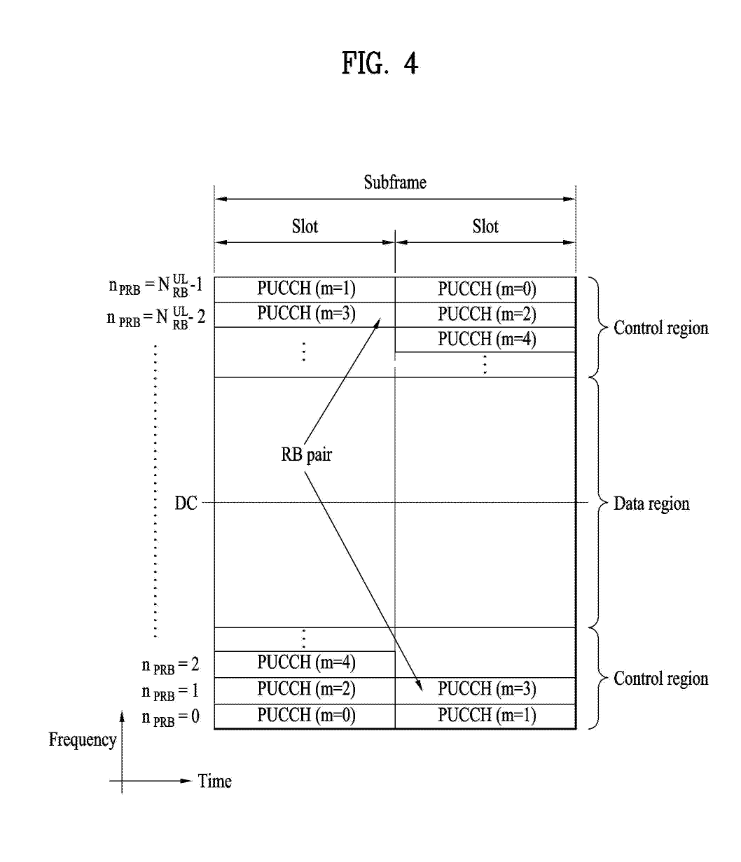

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR | |
| | | (exist or | (Scheduling | |
| | | absent) | Request) | |
| 1a | BPSK | 1 | ACK/NACK or | One |
| | | | SR + ACK/NACK | codeword |
| 1b | QPSK | 2 | ACK/NACK or | Two |
| | | | SR + ACK/NACK | codeword |
| 2 | QPSK | 20 | CQI/PMI/RI | Joint |
| | | | | coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

[Self-Contained Subframe Structure]

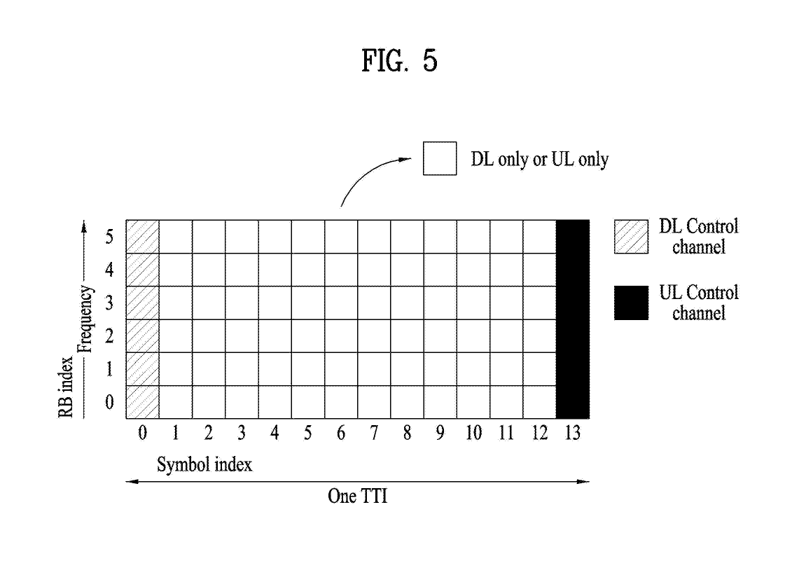

For the purpose of minimizing latency in 5th-generation (5G) new RAT, a structure in which a control channel and a data channel are time-division-multiplexed (TDMed) as illustrated in FIG. 5 may be considered as one frame structure.

In FIG. 5, a hatched region represents a DL control region and a black region represents a UL control region. An unmarked region may be used for DL data transmission or UL data transmission. This structure is characterized in that DL transmission and UL transmission are sequentially performed in one subframe so that DL data may be transmitted and a UL ACK/NACK signal may be received in the subframe. As a result, the time taken to retransmit data when a data transmission error occurs may be reduced, thereby minimizing the latency of final data transmission.

In such a subframe structure in which the data channel and the control channel are TDMed, a time gap is needed for the process of switching from a transmission mode to a reception mode or from the reception mode to the transmission mode of the eNB and UE. To this end, some OFDM symbols at the time of switching from DL to UL in the subframe structure are configured as a guard period (GP).

[Analog Beamforming]

In millimeter wave (mmW), wavelength is shortened and thus a plurality of antennas may be installed in the same area. That is, a total of 100 antenna elements may be installed in a panel of 5-by-5 cm in a 30-GHz band with a wavelength of about 1 cm in a 2-dimensional array at intervals of 0.5λ (wavelength). Therefore, in mmW, increasing coverage or throughput by increasing beamforming (BF) gain using multiple antenna elements is taken into consideration.

If a transceiver unit (TXRU) is provided for each antenna element to enable adjustment of transmission power and phase, independent BF may be performed for each frequency resource. However, installing TXRUs in all of about 100 antenna elements is less feasible in terms of cost. Therefore, a method of mapping a plurality of antenna elements to one TXRU and adjusting the direction of a beam using an analog phase shifter is considered. This analog BF method may make only one beam direction in the whole band and thus may not perform frequency selective BF, which is disadvantageous.

Hybrid BF with B TXRUs that are fewer than Q antenna elements as an intermediate form of digital BF and analog BF may be considered. In the case of hybrid BF, the number of directions in which beams may be transmitted at the same time is limited to B or less, which depends on the method of connection of B TXRUs and Q antenna elements.

In next-generation new RAT, support of both paired spectrums (e.g., FDD) and unpaired spectrums (e.g., TDD) is considered. In the paired spectrums, a DL spectrum and a UL spectrum generally use separated frequency bands to perform DL transmission and UL transmission, respectively, and a frequency band of a predetermined size called a duplex gap is allocated between the DL spectrum and the UL spectrum. Next-generation new RAT may be designed to enable an operation of transmitting/receiving a signal of different usage from original usage of a spectrum in order to flexibly use resources. Specifically, in order to improve resource use efficiency of asymmetrical DL/UL data traffic, UL signal transmission may be performed in the DL spectrum of the paired spectrums or DL signal transmission may be performed in the UL spectrum of the paired spectrums.

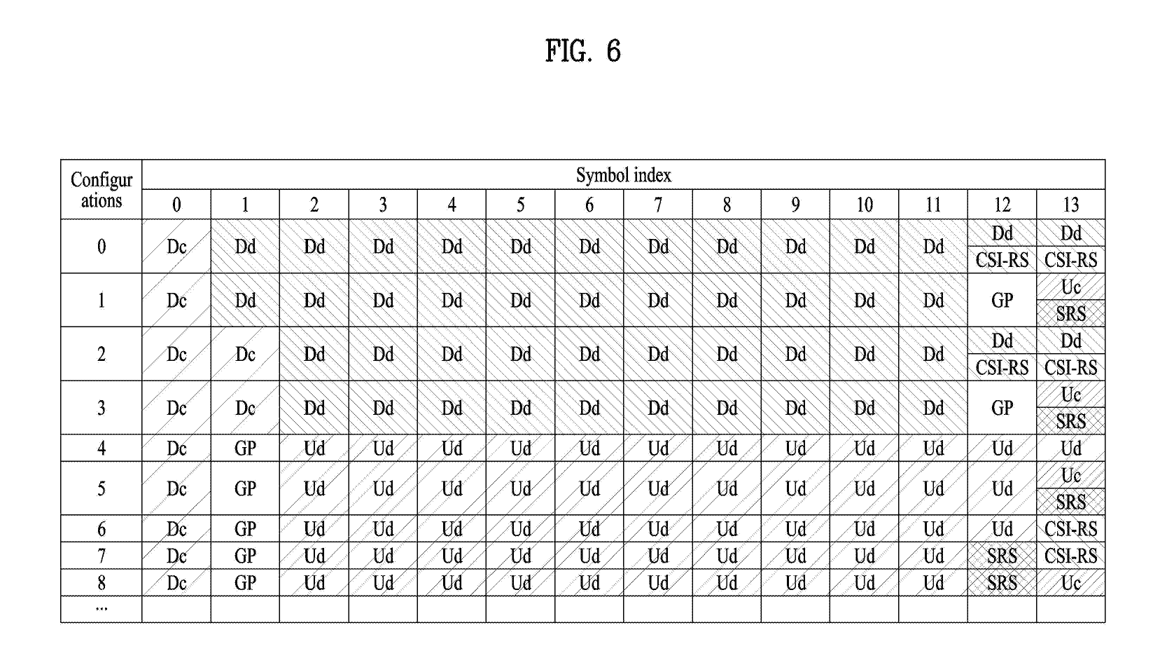

Meanwhile, as mentioned in regard to new RAT, the self-contained subframe structure in which both DL transmission and UL transmission are present in one subframe is considered. FIG. 6 illustrates examples of subframe configuration considered in new RAT. Herein, the subframe configuration refers to configuration as to how some or all of a DL control region, a DL data region, a GP, a UL control region, and a UL data region constitute a subframe (more generally, a time unit longer than a predefined/scheduled symbol) in symbol units (or predefined/scheduled time units). Dc, Dd, GP, Uc, and Ud represent the DL control region, the DL data region, the GP, the UL control region, and the UL data region, respectively.

Transmission and Reception with Flexible Resource Configuration

Subframe Configuration in Specific Subframe

It may be regulated that subframe configuration (which may be referred to as, for example, “slot format related information”) in a specific spectrum is explicitly included in DL control channel information in the specific spectrum or another spectrum and then is indicated to the UE. As another method, the subframe configuration may be indicated through a higher layer signal in the specific spectrum or another spectrum.

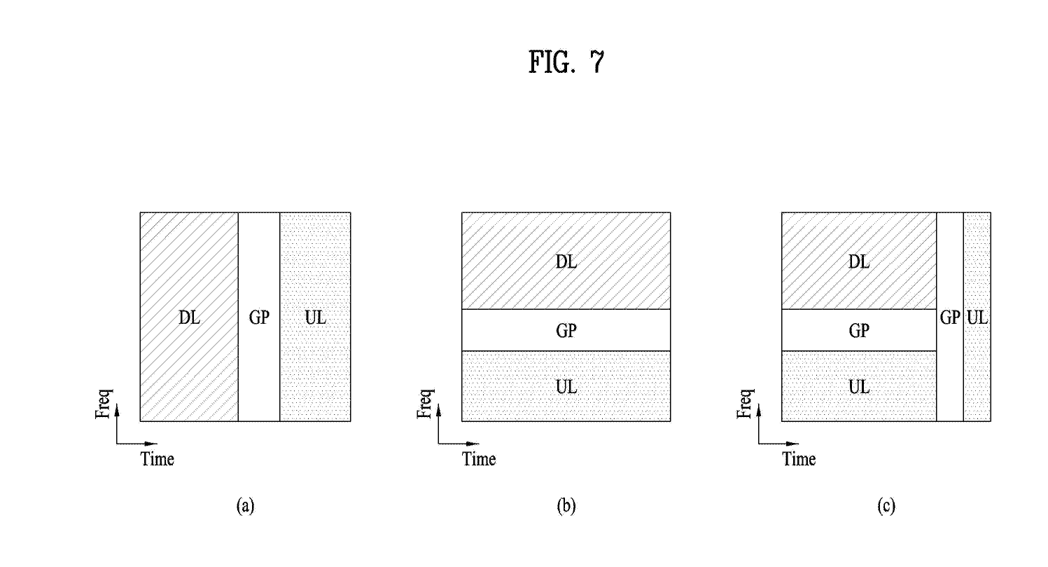

The subframe configuration in the specific spectrum, configured for the UE, refers to configuration as to how some or all of the DL control region, the DL data region, the GP, the UL control region, and the UL data region constitute time/frequency resources in a subframe (more generally, in time/frequency resources of a predefined/scheduled specific size) and may include information about a range of a time/frequency resource region and/or a period/offset to which the subframe configuration is to be applied. For example, it may be regulated that subframe configuration in a UL spectrum is configured such that some or all of DL (DL control and/or DL data), GP, and UL (UL control and/or UL data) regions are divided in time units, in frequency units, or in a combination of time and frequency units. FIG. 7 illustrates a detailed example of the subframe configuration in the UL spectrum.

The subframe configuration may be configured cell-commonly, commonly configured only for grouped specific terminals, i.e., configured terminal-group-specifically, or terminal-specifically configured. Signaling for the subframe configuration may be transmitted on a DL carrier associated with each subframe or on a flexibly used subcarrier. When corresponding signaling is not detected, a fallback operation of the terminal may be defined to conform to a basically defined/scheduled (or signaled) specific subframe type (e.g., UL subframe).

Processing when DL/UL Transmission for Multiple Terminals Overlaps

When this signaling is introduced, it is assumed that a terminal that does not support the signaling is present and a default subframe type is configured for such a terminal. Therefore, depending on terminals, a terminal may recognize a specific subframe as a UL subframe or another terminal may recognize the specific subframe as another subframe type as illustrated in (a) of FIG. 7. In this case, UL transmission (in one or more subframes) of the terminal that recognizes the specific subframe as the UL subframe and DL/UL transmission for the UE that recognizes the specific subframe as a specific subframe type or an additional subframe type may simultaneously occur. If a network does not support simultaneous DL/UL transmission, UL transmission of a non-advanced terminal may be punctured during a time duration in which DL transmission is performed with respect to a terminal that can appreciate the above-described subframe configuration related indication or supports a flexible duplex operation, i.e., an advanced terminal. It is assumed that performance degradation of the non-advanced terminal through this operation may be recovered through retransmission.

Conversely, it may be regulated that, while the non-advanced terminal performs UL transmission, DL transmission of the advanced terminal is punctured.

More generally, in this case, an unpaired spectrum or a DL-only carrier may be configured in an f2 (UL) spectrum for a terminal that has accessed a corresponding cell (e.g., an ultra-reliable low latency communication (URLLC) terminal) through a f1 (DL) or f2 spectrum, without being limited to the terminal supporting flexible duplex and the URLLC terminal may monitor DL control/data in the f2 spectrum after configuration. Alternatively, the terminal may attempt to detect data on every symbol (or on several symbols) under the assumption that data can be transmitted on a specific symbol without DL control. From the viewpoint of the network, for intermittent data transmission generated with respect to the URLLC terminal, the URLLC terminal or service may be supported by a method of puncturing UL data without deteriorating resources of the DL spectrum. This method may be applied to a carrier defined as an unpaired spectrum and UL transmission may be punctured by short DL burst transmission by implementation of the network. For fast data recovery, a segment of an outer code may be indicated to be transmitted during retransmission. This operation may be equally applied to other signaling schemes.

Processing for Transmission not Supporting Retransmission

As described above, when punctured retransmission is for data, retransmission may be applied. However, in the case of a UL channel without retransmission (e.g., ACK/NACK (A/N) transmission), if retransmission is not applied, processing for DL data transmission is ambiguous. To prevent this phenomenon, it may be regulated that it is assumed that the UL channel without retransmission (e.g., A/N transmission) is not punctured and the network or eNB transmits a retransmission request for A/N transmission. It is assumed that the A/N retransmission request can be performed very fast and can be transmitted in a subsequent subframe or after a plurality of subframes (or after a predefined/scheduled time or a signaled time) after A/N transmission is performed. Alternatively, it may be generally assumed that an ACK or NACK signal of the network for A/N transmission is transmitted in a subsequent subframe or after a plurality of subframes (or after a predefined/scheduled or signaled time) after A/N transmission is performed. When NACK occurs for A/N transmission (or when DTX occurs), the terminal may immediately retransmit A/N. It is assumed that legacy resources are reused during retransmission or new resources are used during retransmission when there is an explicit request.

Alternatively, a specific UE (e.g., URLLC terminal) for f1 and f2 spectrums may support simultaneous monitoring (therefore, the terminal may transmit data through the f1 or f2 spectrum) or a frequency for which monitoring is supported in each subframe may be dynamically or semi-statically configured for the terminal.

As described above, when specific UL transmission (e.g., PUCCH or A/N transmission) without retransmission is punctured, the terminal may perform UL transmission in a predefined/signaled fallback subband. Herein, the fallback subband may be used for other purposes (e.g., PUSCH transmission) when the subband is not used for UL transmission.

UL A/N transmission timelines which are applied to the case in which a UL A/N transmission resource is punctured and the case in which the resource is not punctured may be preconfigured or signaled. For example, maximum PUCCH resource(s) should be prescheduled in consideration of the possibility that the UL A/N transmission resource is to be punctured. PUCCH resource(s) based on the UL A/N transmission timeline which are applied when the UL A/N transmission resource is not punctured are preferentially stacked. UL A/N transmission related resources which are additionally transmitted when the UL A/N transmission resource is punctured may be stacked with low priority. For example, the resources stacked with low priority may be used for other purposes (e.g., PUSCH transmission) when the resources are not used for UL A/N transmission.

Special Transmission and Reception Method

During UL data/control transmission of URLLC, corresponding transmission may be performed in a UL spectrum and, in order to reduce latency, for example, in transmission of a scheduling request (SR), data transmission may be performed on one of preset resources. In this case, corresponding transmission may impact on UL transmission of other UEs. To reduce such an impact, a restriction on resources at least in terms of a frequency may be considered. In the case of a terminal, reliability of which is important, the terminal may persistently perform UL transmission until the network or the eNB receives ACK. Such repetitive transmission and reception may be performed on a designated resource. To identify that the same data is repeatedly transmitted, it may be assumed that a time/frequency resource for data transmission is determined according to a predefined/scheduled or signaled pattern during repetitive transmission and reception. It is assumed that the time/frequency resource is reset when new data transmission occurs so as to distinguish between resources. Alternatively, whether corresponding transmission or reception is repetitive transmission or repetitive reception may be signaled by RS scrambling.

In this case, since collision may be persistently generated due to different transmission or reception, the UE may simultaneously transmit the SR. In other words, when ACK is not transmitted for a predetermined time due to collision, the terminal may perform dedicated UL transmission through the SR. The network may transmit a UL grant only for the case of the SR of the terminal that has not transmitted ACK. In this case, the terminal that has transmitted ACK may skip UL transmission for the received UL grant.

Signaling of Transmission Medium of Subframe Configuration

A time/frequency resource and/or a spectrum in which a specific channel (e.g., DL control channel) including subframe configuration can be transmitted may be predefined/scheduled or may be configured by a higher layer or physical layer signal. It may be regulated that the terminal may monitor the specific channel including the subframe configuration only with respect to the spectrum and/or the time/frequency resource. The channel including the subframe configuration is not limited to the DL control channel and may be transmitted on other channels.

Resource Region Scheduled or Configured for Control Channel

It may be regulated that a channel of a specific type (control channel) is always transmitted and received on a specific time/frequency resource in a specific spectrum regardless of subframe configuration described above. As an example, it may be regulated that the last N symbols in a subframe of a UL spectrum are defined as a UL control region with respect to all (or predefined/scheduled or signaled) frequency bands in the corresponding spectrum and only a UL control channel and/or a UL reference signal such as an SRS is transmitted in the corresponding region. In this case, a time/frequency resource on which UCI can be transmitted in the subframe of the UL spectrum may always be guaranteed and a corresponding terminal may coexist with a terminal that does not support flexible/full duplex on the corresponding resource.

Alternatively, it may be regulated that a start/end timing of a specific region in the specific spectrum is fixed regardless of the subframe configuration. As an example, it may be regulated that a UL control region is always started in an n-th symbol in the subframe of the UL spectrum.

HARQ-ACK Transmission in Flexible/Full Duplex Resource

This proposal considers the case in which flexible/full duplex is supported in a network in which paired spectrums are deployed. Characteristically, DL-only transmission is performed in a DL spectrum out of the paired spectrums, whereas DL transmission is permitted in a UL spectrum so that resource use efficiency in a heavy DL traffic environment may be improved. For example, subframe configuration 0 or 2 of FIG. 6 may be used in the DL spectrum and one of subframe configurations 1, 3, 4, 5, 6, and 7 of FIG. 6 may be used in the UL spectrum. In this way, when DL transmission is permitted in the UL spectrum out of the paired spectrums, it may be regulated that DL/UL transmission in each spectrum is performed as follows.
DL scheduling may be performed in a DL control region of the DL spectrum and HARQ-ACK feedback for corresponding DL data may be performed in a UL control region of the UL spectrum.
Type related signaling and/or DL/UL scheduling of a corresponding subframe is performed in a DL control region of the UL spectrum. HARQ-ACK feedback for DL/UL data may be performed in the UL control region of the UL spectrum.
A CSI-RS may be transmitted in both the DL spectrum and the UL spectrum. CSI feedback may be transmitted in the UL control or UL data region of the UL spectrum.
It may be regulated that an SRS is transmitted only in the UL spectrum.

It may be regulated that a transmission timing of HARQ-ACK feedback for DL data is adaptively changed according to traffic load of the DL data. Characteristically, when a time duration of DL data scheduled by specific DL control is a scheduling unit, a HARQ-ACK transmission timing for the DL data scheduled for the terminal may be determined by the size of the scheduling unit. Since a processing time for decoding the DL data and encoding a HARQ-ACK for the DL data may vary with the amount of the DL data scheduled for the terminal, the HARQ-ACK transmission timing may be adaptively changed according to the amount of the DL data.

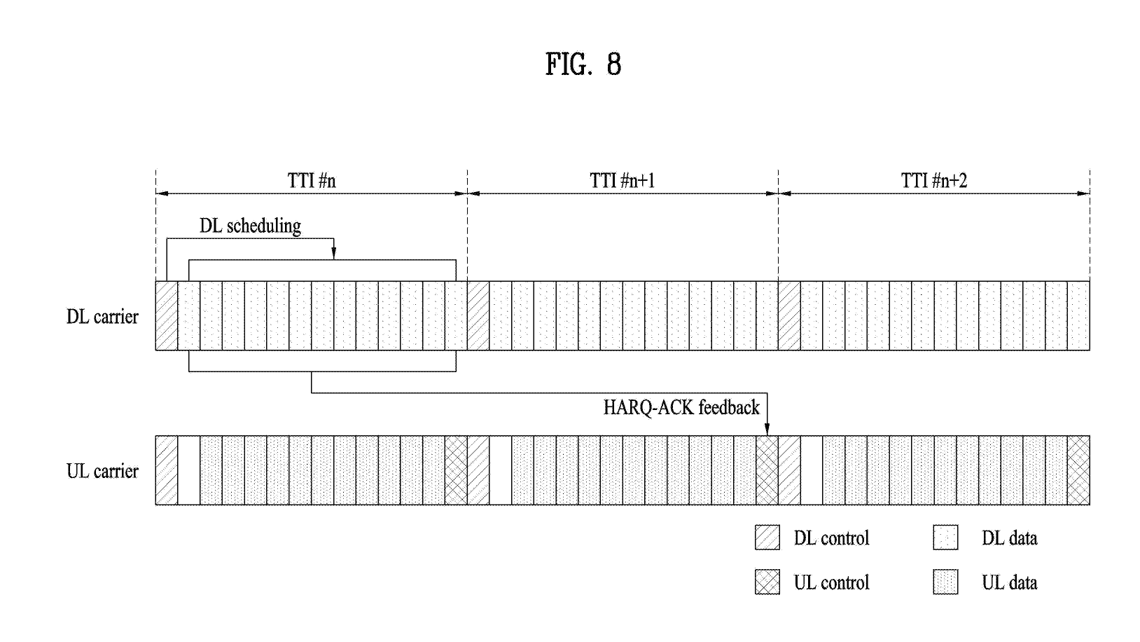

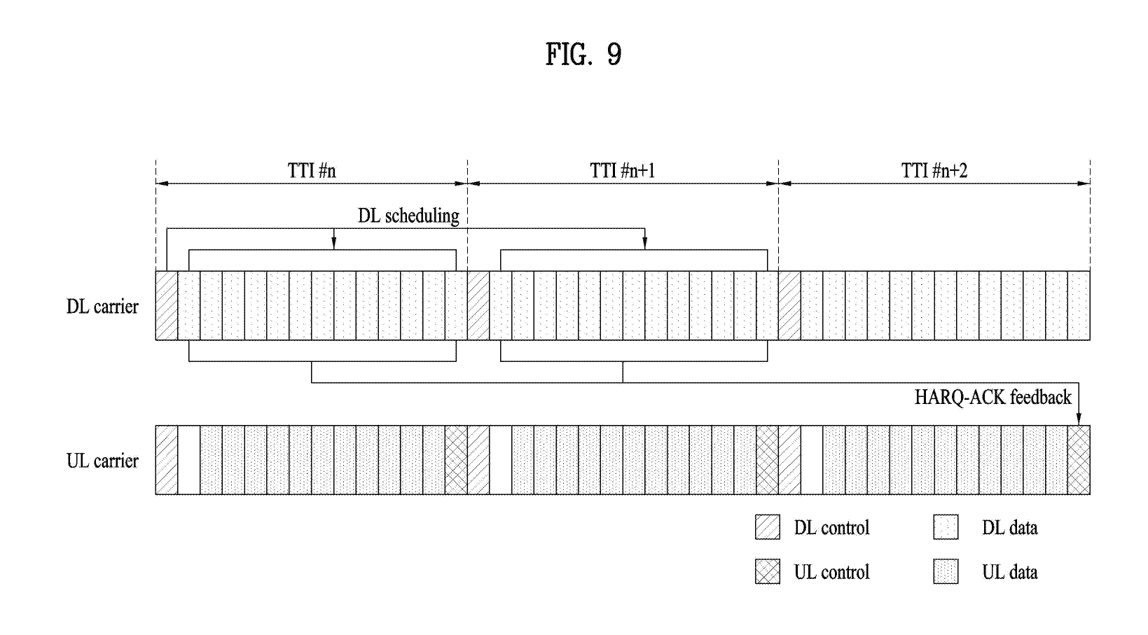

As an example, assuming that subframe configuration 0 of FIG. 6 is set in the DL spectrum and subframe configuration 5 of FIG. 6 is set in the UL spectrum, it may be regulated that a HARQ-ACK transmission timing when a DL data channel scheduled by DL control in TTI #n is transmitted in TTI #n is determined to be TTI #n+1 as illustrated in FIG. 8, whereas a HARQ-ACK transmission timing when a DL data channel scheduled by DL control in TTI #n is transmitted in TTI #n and TTI #n+1 is determined to be TTI #n+2 as illustrated in FIG. 9.

The HARQ-ACK transmission timing described above may be determined to be the earliest TTI including UL control transmission after a predefined/scheduled time duration from the last TTI (or from the last symbol) of scheduled DL data. Characteristically, the time duration for determining the HARQ-ACK transmission timing may be defined as a function of a scheduling unit. Alternatively, information about the HARQ-ACK transmission timing may be explicitly included in information of a control channel for DL (scheduling) grant and then may be indicated to the terminal.

If subframe configuration in which a UL control transmission symbol is not present in the UL spectrum is set, the HARQ-ACK transmission timing may be determined according to one of the following regulations.
Proposal 1: HARQ-ACK may be transmitted in the nearest TTI including UL control transmission after a TTI corresponding to a timing at which HARQ-ACK is to be transmitted.
Proposal 2: HARQ-ACK may be transmitted on the last UL data symbol in a TTI corresponding to a timing at which HARQ-ACK is to be transmitted. In this case, a resource region (frequency/time resource) to which HARQ-ACK is to be mapped in a UL data symbol may be predefined/scheduled or signaled.

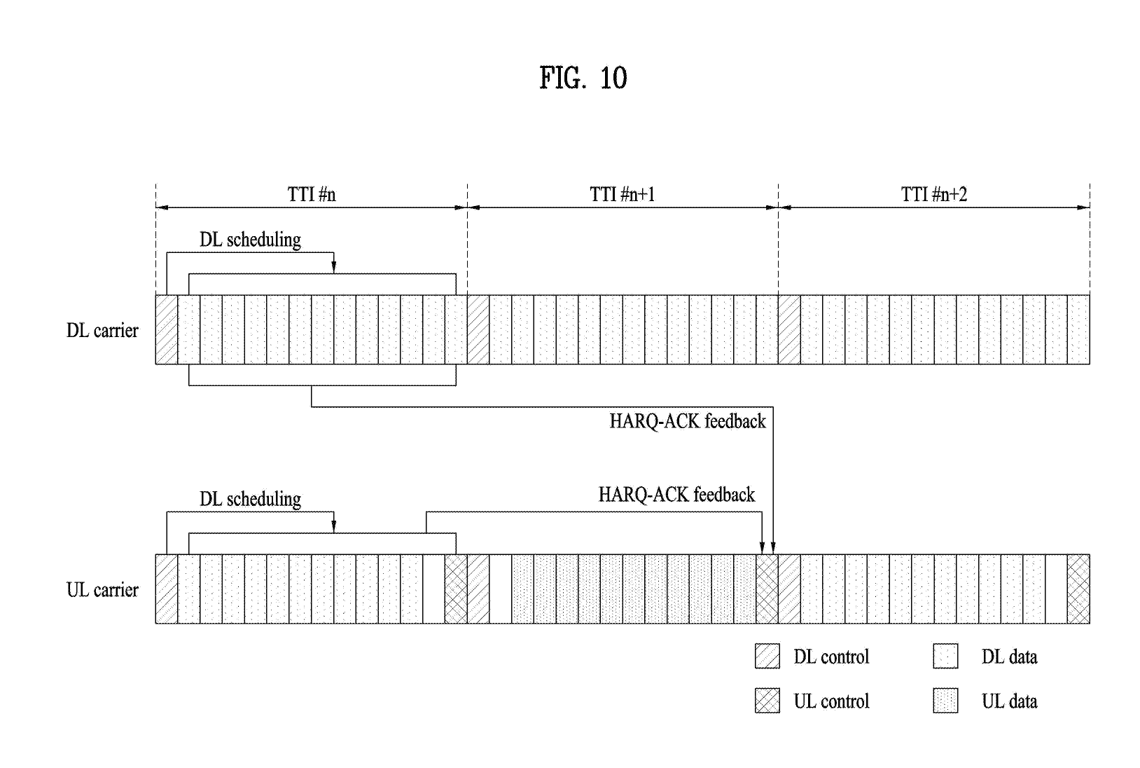

It may be regulated that HARQ-ACKs for DL data scheduled in the DL spectrum and the UL spectrum are transmitted through multiplexing. As an example, when HARQ-ACK timings for DL data scheduled in the DL spectrum and the UL spectrum in TTI #n illustrated in FIG. 10 are equal, HARQ-ACKs may be multiplexed at the same timing and then be transmitted.

In this case, it may be regulated that HARQ-ACKs for a plurality of data channels multiplexed at the same timing are joint-coded and then are transmitted on one UL channel. Characteristically, it may be regulated that priorities of HARQ-ACKs are determined and a HARQ-ACK having a high priority is mapped to be allocated to an earlier index (e.g., RE index). For example, the HARQ-ACK having a high priority may be mapped to be arranged in an earlier index and this serves to cause the corresponding HARQ-ACK to be robust against errors (in a scheme such as Reed-Muller (RM) coding).

It may be regulated that a HARQ-ACK for a data channel scheduled in the DL spectrum has a high priority among priorities of HARQ-ACKs for a plurality of data channels multiplexed at the same timing. As another method, it may be regulated that a HARQ-ACK for a faster TTI timing at which the data channel is scheduled has a high priority. As another method, a HARQ-ACK for a data channel corresponding to retransmission has a higher priority than a HARQ-ACK for a data channel corresponding to initial transmission.

In an operation in which HARQ-ACKs for the DL data scheduled in the DL spectrum and the UL spectrum are multiplexed at the same timing, it may be regulated that a payload size of HARQ-ACK transmission is limited or the number of multiplexed HARQ-ACKs is limited. If dropping of a specific HARQ-ACK is needed due to such limitation, the above-described priorities of HARQ-ACKs for multiple data channels multiplexed at the same timing may be applied to dropping. Alternatively, (spatial) bundling may be applied to the specific HARQ-ACK due to the limitation. As an example, bundling may be applied only to a HARQ-ACK for DL data scheduled in the same spectrum or bundling may be limitedly applied in scheduled order in consideration of a scheduled timing.

Alternatively, it may be regulated that HARQ-ACKs for DL data scheduled in the DL spectrum and the UL spectrum are separately coded and are transmitted on separate channels. In addition, it may be regulated that a UL channel including a HARQ-ACK for DL data scheduled in a specific spectrum is regarded as a low priority and corresponding UL channel transmission is delayed. For example, it may be regulated that a HARQ-ACK for DL data scheduled in the UL spectrum is configured to have a lower priority than a HARQ-ACK for DL data scheduled in the DL spectrum and is transmitted in the nearest TTI including UL (control/data) transmission after a corresponding TTI in the case of the same HARQ-ACK transmission timing.

The above regulations may be similarly extended/applied to HARQ-ACK transmission when plural DL data is scheduled in a specific spectrum.

The examples of the above-described proposed methods may also be included in one of implementation methods of the present invention, and, therefore, it is obvious that the examples are regarded as the proposed methods. In addition, although the above-described proposed methods may be independently implemented, the proposed methods may be implemented in the form of a combination (or aggregate) of some of the proposed methods. Information as to whether the proposed methods are applied (or information about regulations of the proposed methods) may be indicated to the terminal by the eNB through a predefined signal (e.g., physical layer or higher layer signal).

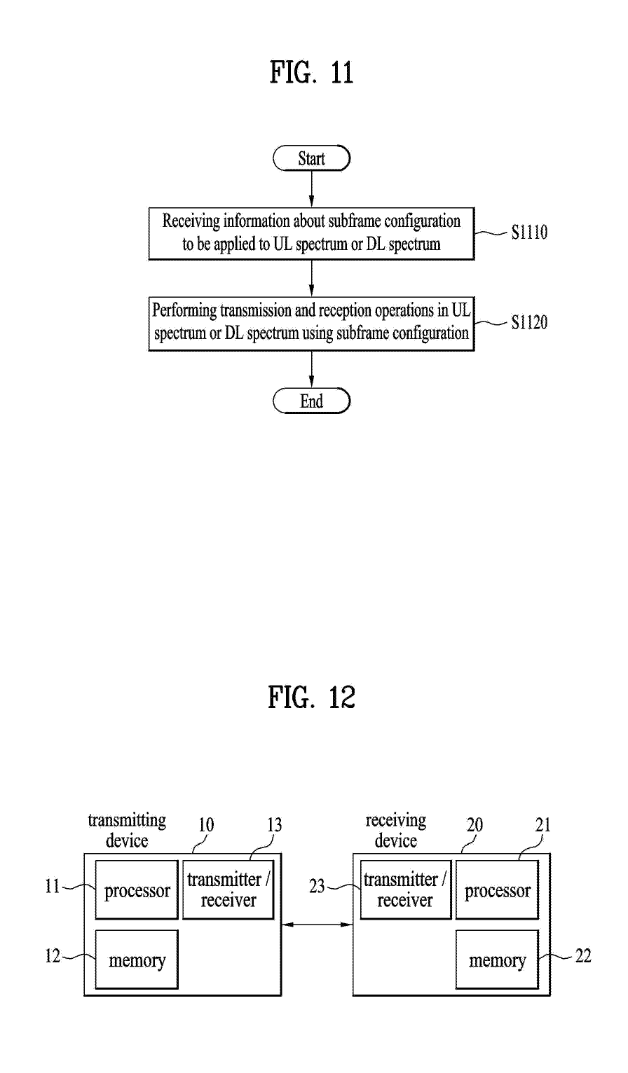

FIG. 11 illustrates the operation of a terminal according to an embodiment of the present invention.

The present invention provides a transmission and reception method for a terminal for which a pair of UL spectrum and a DL spectrum is configured in a wireless communication system. The terminal may receive information about subframe configuration to be applied to the UL spectrum or the DL spectrum from a network (S1110). The terminal may perform transmission and reception operations in the UL spectrum or the DL spectrum using the received subframe configuration (S1120). The subframe configuration may indicate a DL related operation in the UL spectrum or indicate a UL related operation in the DL spectrum

The subframe configuration may be included in DL control information received in a spectrum in which the transmission and reception operations are to be performed or other spectrums.

The subframe configuration may indicate information about how at least a part of a DL control region, a DL data region, a GP region, a UL control region, and a UL data region is configured in a subframe.

In addition, the subframe configuration may include information about a time or frequency resource range, a period, or an offset to which the subframe configuration is to be applied.

The subframe configuration may be configured cell-commonly, terminal group-specifically, or terminal-specifically.

When DL transmission of the terminal based on the received subframe configuration overlaps with UL transmission of another UE, the UL transmission of the another terminal may be punctured. When DL transmission of the terminal based on the received subframe configuration overlaps with UL transmission of another terminal, the DL transmission of the terminal may be punctured.

A spectrum in which the subframe configuration is received and a time or frequency resource in the spectrum may be pre-configured for the terminal.

HARQ-ACK feedbacks for DL data scheduled in the UL spectrum and the DL spectrum according to the received subframe configuration may be multiplexed and transmitted on a UL control channel in one of the UL spectrum and the DL spectrum.

RE mapping of the HARQ-ACK feedbacks to the UL control channel may be performed based on priorities of the HARQ-ACK feedbacks. A HACK-ACK for DL data scheduled in the DL spectrum may have a higher priority than a HARQ-ACK for DL data scheduled in the UL spectrum. A HARQ-ACK for DL data scheduled in an earlier TTI may have a higher priority than a HARQ-ACK for DL data scheduled in a later TTI.

While embodiments of the present invention have been briefly described with reference to FIG. 11, an embodiment related to FIG. 11 may alternatively or additionally include at least a part of the aforementioned embodiment(s).

FIG. 12 is a block diagram of a transmitting device 10 and a receiving device 20 configured to implement exemplary embodiments of the present invention. Referring to FIG. 12, the transmitting device 10 and the receiving device 20 respectively include transmitter/receiver 13 and 23 for transmitting and receiving radio signals carrying information, data, signals, and/or messages, memories 12 and 22 for storing information related to communication in a wireless communication system, and processors 11 and 21 connected operationally to the transmitter/receiver 13 and 23 and the memories 12 and 22 and configured to control the memories 12 and 22 and/or the transmitter/receiver 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the transmitter/receiver 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the transmitter/receiver 13 may include an oscillator. The transmitter/receiver 13 may include Nt (where Nt is a positive integer) transmit antennas.

A signal processing process of the receiving device 20 is the reverse of the signal processing process of the transmitting device 10. Under the control of the processor 21, the transmitter/receiver 23 of the receiving device 10 receives RF signals transmitted by the transmitting device 10. The transmitter/receiver 23 may include Nr receive antennas and frequency down-converts each signal received through receive antennas into a baseband signal. The transmitter/receiver 23 may include an oscillator for frequency down-conversion. The processor 21 decodes and demodulates the radio signals received through the receive antennas and restores data that the transmitting device 10 wishes to transmit.

The transmitter/receiver 13 and 23 include one or more antennas. An antenna performs a function of transmitting signals processed by the transmitter/receiver 13 and 23 to the exterior or receiving radio signals from the exterior to transfer the radio signals to the transmitter/receiver 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An transmitter/receiver supporting a MIMO function of transmitting and receiving data using a plurality of antennas may be connected to two or more antennas.

In embodiments of the present invention, the UE or the terminal operates as the transmitting device 10 on uplink, and operates as the receiving device 20 on downlink. In embodiments of the present invention, the eNB or the base station operates as the receiving device 20 on uplink, and operates as the transmitting device 10 on downlink.

The transmitting device and/or the receiving device may be configured as a combination of one or more embodiments of the present invention.

It will be apparent to those skilled in the art that various modifications and variations can be made in the present invention without departing from the scope of the inventions. Thus, it is intended that the present invention covers the modifications and variations of this invention provided they come within the scope of the appended claims and their equivalents.

### INDUSTRIAL APPLICABILITY

The present invention is applicable to wireless communication devices such as a terminal, a relay, and a base station.

1. A method for transmitting and receiving for a terminal for which a pair of an uplink (UL) spectrum and a downlink (DL) spectrum is configured in a wireless communication system, the method comprising:
receiving information about subframe configuration to be applied to the UL spectrum or the DL spectrum from a network; and
performing transmission and reception operations using the subframe configuration in the UL spectrum or the DL spectrum,
wherein the subframe configuration indicates a DL related operation of the terminal in the UL spectrum or indicates a UL related operation of the terminal in the DL spectrum, and
the subframe configuration is included in DL control information received in a spectrum in which the transmission and reception operations are to be performed or other spectrums.

2. The method of claim 1, wherein the subframe configuration indicates information about how at least a part of a DL control region, a DL data region, a guard period region, a UL control region, and a UL data region is configured in a subframe.

3. The method of claim 1, wherein the subframe configuration includes information about a time or frequency resource range, a period, or an offset to which the subframe configuration is to be applied.

4. The method of claim 1, wherein the subframe configuration is configured cell-commonly, terminal group-specifically, or terminal-specifically.

5. The method of claim 1, wherein when a DL transmission of the terminal based on the received subframe configuration overlaps with an UL transmission of another terminal, the UL transmission of the another terminal is punctured.

6. The method of claim 1, wherein when a DL transmission of the terminal based on the received subframe configuration overlaps with an UL transmission of another terminal, the DL transmission of the terminal is punctured.

7. The method of claim 1, wherein a spectrum in which the subframe configuration is received and a time or frequency resource in the spectrum are pre-configured for the terminal.

8. The method of claim 1, wherein hybrid automatic repeat request acknowledgement/non-acknowledgement (HARQ-ACK) feedback for DL data scheduled in each of the UL spectrum and the DL spectrum according to the received subframe configuration is multiplexed and transmitted on a UL control channel in one of the UL spectrum and the DL spectrum.

9. The method of claim 8, wherein
resource element (RE) mapping of the HARQ-ACK feedback to the UL control channel is performed based on priority of the HARQ-ACK feedback, and
a HACK-ACK for DL data scheduled in the DL spectrum has a higher priority than a HARQ-ACK for DL data scheduled in the UL spectrum, and
a HARQ-ACK for DL data scheduled in an earlier transmission time interval (TTI) has a higher priority than a HARQ-ACK for DL data scheduled in a later TTI.

10. A terminal for which a pair of an uplink (UL) spectrum and a downlink (DL) spectrum is configured in a wireless communication system, the terminal comprising:
a transmitter and a receiver; and
a processor configured to control the transmitter and the receiver,
wherein the processor is configured to:
receive information about subframe configuration to be applied to the UL spectrum or the DL spectrum from a network; and
perform transmission and reception operations using the received subframe configuration in the UL spectrum or the DL spectrum,
the subframe configuration indicates a DL related operation of the terminal in the UL spectrum or indicates a UL related operation of the terminal in the DL spectrum, and
the subframe configuration is included in DL control information received in a spectrum in which the transmission and reception operations are to be performed or other spectrums.
